(19) United States
(12) Patent Application Publication
(10) Pub. No.: US 2023/0363966 A1
(43) Pub. Date: Nov. 16, 2023

(54) DUAL-STRAP HOISTING DEVICE AND PATIENT LIFT APPARATUS COMPRISING THE SAME

(71) Applicant: Invacare International GmbH, Witterswil (CH)

(72) Inventors: Petrus Henricus Maria STOKMAN, Kaiseraugst (CH); Tiago DE SEIXAS GUIMARÃES, Senhora da Hora (PT); Henrique GONÇALVES, Alfena (PT); Mark MONTEIRO, Badhoevedorp (NL)

(21) Appl. No.: 18/044,798

(22) PCT Filed: Sep. 2, 2021
(86) PCT No.: PCT/IB2021/058038

§ 371 Date: Mar. 10, 2023

(30) Foreign Application Priority Data
Sep. 11, 2020 (EP) 20195686.9
Sep. 11, 2020 (EP) 20195690.1

(51) Int. Cl. A61G 7/10

(52) U.S. Cl. CPC A61G 7/1015; A61G 7/1051; A61G 2203/44

(57) ABSTRACT

There is in particular described a hoisting device for a patient lift apparatus, comprising first and second lifting straps configured to selectively lift or lower a patient, first and second winding spools configured to allowing winding or unwinding of the first and second lifting straps, respectively, and a driving arrangement configured to drive the first and second winding spools so as to selectively wind or unwind the first and second lifting straps. The driving arrangement comprises a first electric motor in driving connection with the first winding spool and a second electric motor sin driving connection with the second winding spool, the first and second electric motors being operable in synchronism to wind or unwind the first and second lifting straps. The hoisting device further comprises a first guide roller whose circumferential surface contacts a first side of the first lifting strap and a second guide roller whose circumferential surface contacts a first side of the second lifting strap. Each of the first and second guide rollers is supported by a one-way bearing configured such that each of the first and second guide rollers is forcibly driven into rotation upon unwinding of the associated lifting strap from the associated winding spool and is free to rotate in an opposite direction upon winding of the associated lifting strap onto the associated winding spool. Each of the first and second guide rollers is forcibly driven into rotation upon unwinding of the associated lifting strap from the associated winding spool such that a tangential speed of the circumferential surface of each of the first and second guide rollers is greater than an effective tangential speed at which the associated lifting strap is unwound from the associated winding spool.

### RELATED APPLICATIONS

This application is the national stage entry of PCT/162021/058038, filed on Sep. 2, 2021, which claims priority to European Application Nos. 20195686.9, filed Sep. 11, 2020 and 20195690.1 filed Sep. 11, 2020, the entire disclosures of which are incorporated herein by reference.

### TECHNICAL FIELD

The present invention generally relates to a dual-strap hoisting device for a patient lift apparatus employed for lifting and transferring patients, which dual-strap hoisting device can be used in the health care industry, but more favourably for home care applications. The present invention also relates to a patient lift apparatus comprising such a dual-strap hoisting device. The dual-strap hoisting device and patient lift apparatus of the invention are in particular intended to be used for providing safe and comfortable assisted transfers for those patients with limited mobility or with rehabilitation needs, especially for the purpose of transferring a patient from a bed to a chair, and vice versa.

### BACKGROUND OF THE INVENTION

Dual-strap hoisting device and related patient lift apparatuses are already known in the art and commercially available on the market. Examples thereof include for instance Invacare®'s Robin® and Robin® Mover hoists, which include a dual-strap hoisting device that is designed to be suspended under and guided along an overhead track that can be mounted on a ceiling or along walls of a room (or multiple rooms as the case may be) or supported by a suitable gantry structure placed in the room. Such a patient lift apparatus and dual-strap hoisting system are disclosed in International (PCT) Publication No. WO 2005/074853 A1, the content of which is incorporated herein by reference in its entirety.

According to International (PCT) Publication No. WO 2005/074853 A1, the hoisting device comprises a pair of lifting straps configured to selectively lift or lower a patient, each lifting strap being woundable onto or unwoundable from a corresponding winding spool. The two winding spools are driven in synchronism, so as to rotate in the same directions, by means of a single electric motor, whose output shaft drives a centrally-located pinion that cooperates with two pairs of toothed wheels driving the associated winding spools.

This known solution is not entirely satisfactory in that the aforementioned driving mechanism that makes use of a single electric motor to drive the two winding spools imposes restrictions as to the arrangement of the winding spools inside the housing of the hoisting device, which in effect is not optimal. This known driving mechanism furthermore require a suitably powerful electric motor to drive both winding spools.

U.S. Pat. No. 5,553,335 A discloses another example of a dual-strap hoisting device that makes use of a single electric motor to drive a common winding spool for both lifting straps.

Yet another example of a dual-strap hoisting device is disclosed in German Patent No. DE 43 37 527 C2.

International (PCT) Publication No. WO 2005/074853 A1 discusses the inherent drawbacks of the solutions disclosed in U.S. Pat. No. 5,553,335 A and German Patent No. DE 43 37 527 C2.

U.S. Pat. No. 5,809,591 A discloses a patient lift apparatus comprising a gantry structure supporting a single-strap hoisting device, which therefore requires the additional use of a spreader bar to lift a patient.

U.S. Patent Publication No. US 2012/0198612 A1 discloses a hoisting device for a patient lift apparatus. Another similar solution is disclosed in European Patent Publication No. EP 3 510 987 A1. These solutions however fail to provide any adequate control of the tension of the lifting straps during unwinding, which can cause jamming or blocking of the lifting straps upon unwinding.

The aforementioned known solutions are not fully satisfactory, and there therefore remains a need for an improved solution.

### SUMMARY OF THE INVENTION

A general aim of the invention is to provide an improved dual-strip hoisting device suitable for use in a patient lift apparatus.

More specifically, an aim of the present invention is to provide a hoisting device with a driving arrangement driving two winding spools that obviates the limitations of the known solutions.

A further aim of the invention is to provide such a hoisting device that reduces the risk of jamming or blocking of the lifting straps during unwinding operations.

Yet another aim of the invention is to provide such a solution which can appropriately detect any slackening of the lifting straps.

A further aim of the invention is to provide such a solution which ensures robust and secure lifting operations of the patient.

Still another aim of the invention is to provide such a solution that frees space within the hoisting device to incorporate further functionalities such as e.g. a built-in scale.

These aims are achieved thanks to the solutions defined in the claims.

In accordance with a first aspect of the invention, there is provided a hoisting device for a patient lift apparatus comprising (i) first and second lifting straps configured to selectively lift or lower a patient, (ii) first and second winding spools configured to allow winding or unwinding of the first and second lifting straps, respectively, and (iii) a driving arrangement configured to drive the first and second winding spools so as to selectively wind or unwind the first and second lifting straps. The driving arrangement comprises a first electric motor in driving connection with the first winding spool and a second electric motor in driving connection with the second winding spool, the first and second electric motors being operable in synchronism to wind or unwind the first and second lifting straps. According to this first aspect of the invention, the hoisting device further comprises a first guide roller whose circumferential surface contacts a first side of the first lifting strap and a second guide roller whose circumferential surface contacts a first side of the second lifting strap. Each of the first and second guide rollers is supported by a one-way bearing configured such that each of the first and second guide rollers is forcibly driven into rotation upon unwinding of the associated lifting strap from the associated winding spool and is free to rotate in an opposite direction upon winding of the associated lifting strap onto the associated winding spool. Furthermore, each of the first and second guide rollers is forcibly driven into rotation upon unwinding of the associated lifting strap from the associated winding spool such that a tangential speed of the circumferential surface of each of the first and second guide rollers is greater than an effective tangential speed at which the associated lifting strap is unwound from the associated winding spool. This ensures and guarantees appropriate control of the tension of the lifting straps during unwinding, thereby avoiding jamming or blocking of the lifting straps upon unwinding.

According to a preferred embodiment, each of the first and second guide rollers may be forcibly driven into rotation by the associated electric motor via a geartrain. In this latter context, each geartrain preferably includes a toothed wheel coupled to the associated winding spool, a gear wheel coupled to the one-way bearing of the associated guide roller, and an intermediate pinion wheel meshing with the toothed wheel and with the gear wheel.

Advantageously, a ratio of the tangential speed of the circumferential surface of each of the first and second guide rollers to the effective tangential speed at which the associated lifting strap is unwound from the associated winding spool is greater than 1 and up to the order of 2 to 2.5.

By way of preference, the hoisting device further comprises a first spring-loaded idle roller whose circumferential surface contacts a side of the first lifting strap, opposite to the first side, and a second spring-loaded idle roller whose circumferential surface contacts a side of the second lifting strap opposite to the first side. Each of the first and second spring-loaded idle rollers is urged towards the associated guide roller to press the associated lifting strap against the associated guide roller. This ensures that a constant friction is maintained between each lifting strap and the associated guide roller during unwinding operations.

In accordance with a further embodiment, the hoisting device further comprises a third guide roller whose circumferential surface contacts the first lifting strap and a fourth guide roller whose circumferential surface contacts the second lifting strap. Each of the third and fourth guide rollers is journaled in an associated bushing through which the associated lifting strap is guided, the bushing being allowed to move away from a default position, within a limited range of movement, in case of a slackening of the associated lifting strap to cause activation of an associated microswitch designed to signal that the associated electric motor should be turned off.

Each of the first and second electric motors may drive the associated winding spool through a worm gear.

By way of preference, each of the first and second winding spools is coupled to a pair of axially spaced-apart toothed wheels cooperating with a driving pinion driven by the associated electric motor, each winding spool being positioned between the pair of axially spaced-apart toothed wheels.

Advantageously, each of the first and second winding spools further comprises a centrifugal brake element configured to stop undesired swift unwinding of each lifting strap.

In accordance with a further aspect of the invention, the hoisting device further comprises a strain gauge load cell configured to measure load applied on the hoisting device, which strain gauge load cell is positioned in a spacing located between the first and second winding spools.

These latter features in effect form the subject-matter of another aspect of the present invention, which is applicable independently of the aforementioned first aspect. In that respect, in accordance with another aspect of the invention, there is provided a hoisting device for a patient lift apparatus comprising (i) first and second lifting straps configured to selectively lift or lower a patient, (ii) first and second winding spools configured to allow winding or unwinding of the first and second lifting straps, respectively, and (iii) a driving arrangement configured to drive the first and second winding spools so as to selectively wind or unwind the first and second lifting straps. The driving arrangement comprises a first electric motor in driving connection with the first winding spool and a second electric motor in driving connection with the second winding spool, the first and second electric motors being operable in synchronism to wind or unwind the first and second lifting straps. According to this other aspect of the invention, the hoisting device further comprises a strain gauge load cell configured to measure load applied on the hoisting device, which strain gauge load cell is positioned in a spacing located between the first and second winding spools.

The aforementioned strain gauge load cell is in particular designed to provide a measurement of the weight of the patient being lifted by the hoisting device.

In accordance with an advantageous embodiment, the hoisting device may further comprise a display to provide an indication of the load measured by the strain gauge load cell.

The strain gauge load cell may especially be interposed between a structural frame of the hoisting device and a mounting element used to hang the hoisting device on a corresponding support of the patient lift apparatus.

The hoisting device of the invention may further comprise a battery (in particular a rechargeable battery) supplying power to the hoisting device.

Also claimed is a patient lift apparatus comprising a hoisting device in accordance with any of the aforementioned aspects of the invention. The patient lift apparatus may in particular comprise a static support structure and a pivotable transfer structure that is pivotably supported by a bearing portion of the static support structure so as to pivot about a substantially vertical pivot axis, the hoisting device being provided at a radial outward end portion of the pivotable transfer structure.

Further advantageous embodiments of the invention are discussed below.

### BRIEF DESCRIPTION OF THE DRAWINGS

Other features and advantages of the present invention will appear more clearly from reading the following detailed description of embodiments of the invention which are presented solely by way of non-restrictive examples and illustrated by the attached drawings in which:

FIG. 1 is a perspective view of a patient lift apparatus in accordance with a preferred embodiment of the invention, the patient lift apparatus comprising a static support structure, a pivotable transfer structure that is pivotably supported by the static support structure, and a hoisting device provided at a radial outward end portion of the pivotable transfer structure;

FIG. 1A is an enlarged perspective view of the hoisting device provided at the radial outward end portion of the pivotable transfer structure of the patient lift apparatus of FIG. 1;

FIG. 1B is an enlarged perspective view of a bearing portion of the static support structure of the patient lift apparatus of FIG. 1, which bearing portion pivotably supports the pivotable transfer structure;

FIG. 2 is a front view of the patient lift apparatus of FIG. 1;

FIG. 2A is an enlarged front view of the hoisting device as shown in FIG. 2;

FIG. 3 is a side view of the patient lift apparatus of FIG. 1;

FIG. 4 is a top view of the patient lift apparatus of FIG. 1;

FIG. 5A is a perspective view of the hoisting device of FIG. 1 shown in isolation;

FIG. 5B is an enlarged perspective view showing a mounting element of the hoisting device of FIG. 5A;

FIG. 6 is a partial perspective view of the underside of the radial outward end portion of the pivotable transfer structure of FIG. 1, without the hoisting device, showing a mounting slot configured to receive the mounting element of the hoisting device of FIG. 6A;

FIG. 7 is a partial perspective view showing an inner portion of the radial outward end portion of the pivotable transfer structure of FIG. 1, without the hoisting device;

FIG. 8 is a partial view of a cross-section of the radial outward end portion of the pivotable transfer structure showing a portion of the mounting arrangement of the hoisting device;

FIGS. 9A and 9B are perspective views of the hoisting device of FIG. 5A with the housing thereof removed;

FIG. 10 is a perspective view of a longitudinal cross-section of the hoisting device of FIG. 5A as taken along a plane coinciding with the lifting straps;

FIG. 11 is a partial side view of a driving arrangement driving a first winding spool of the hoisting device;

FIG. 11A is a partial side view showing a geartrain of the driving arrangement of FIG. 11; and

FIG. 12 is a partial perspective view of a strain gauge load cell coupled to the mounting element of the hoisting device of FIG. 5A.

### DETAILED DESCRIPTION OF EMBODIMENTS OF THE INVENTION

The present invention will be described in relation to various illustrative embodiments. It shall be understood that the scope of the invention encompasses all combinations and sub-combinations of the features of the embodiments disclosed herein.

As described herein, when two or more parts or components are described as being connected, secured or coupled to one another, they can be so connected, secured or coupled directly to each other or through one or more intermediary parts.

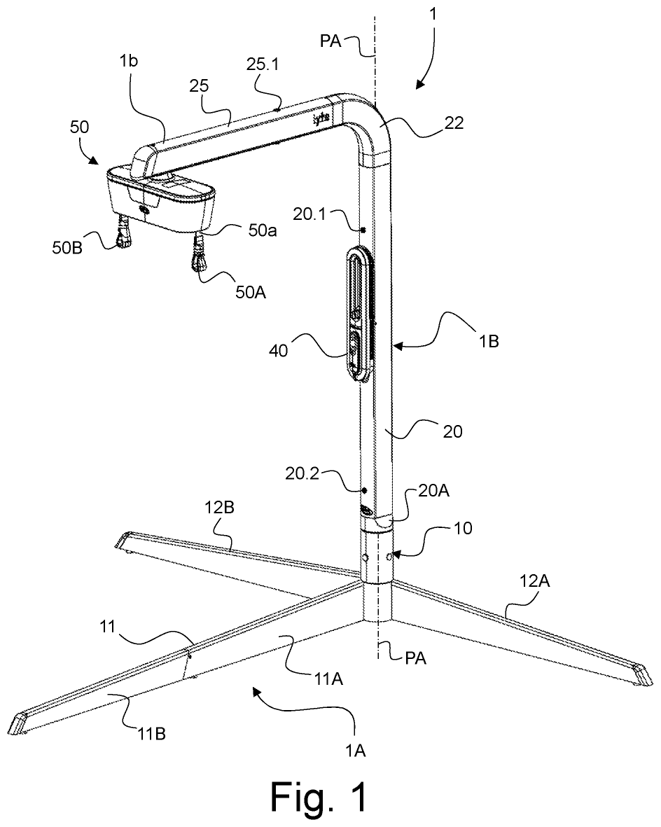

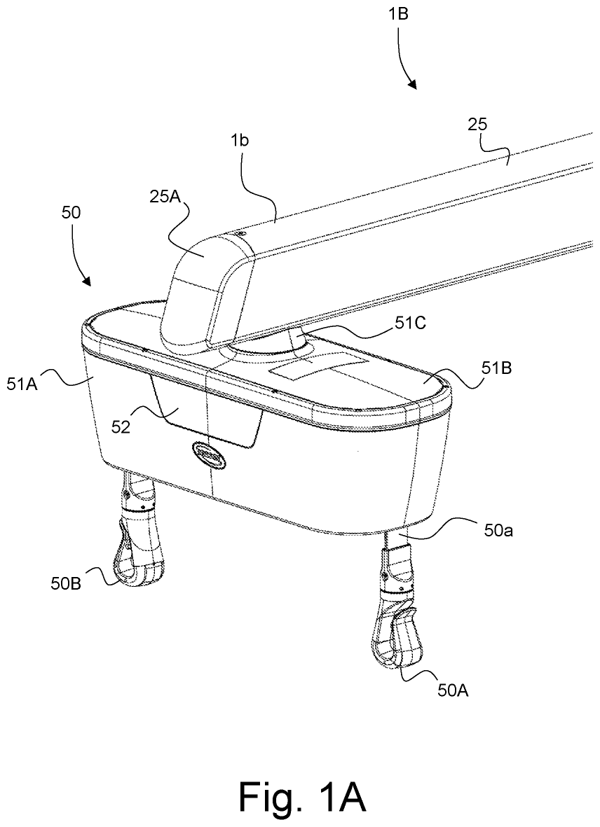

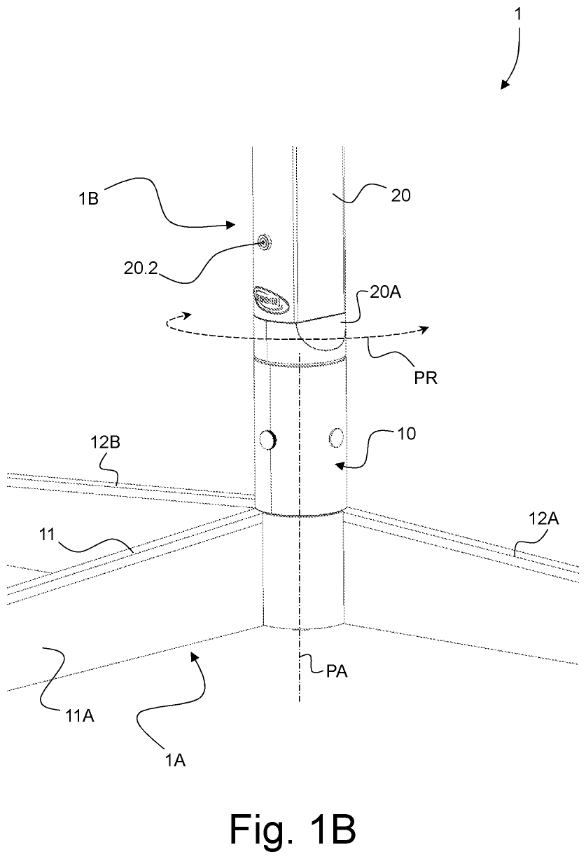

More specifically, the invention will be described in relation to various embodiments of a patient lift apparatus, as depicted in FIGS. 1 to 12. The patient lift apparatus shown in the Figures is generally designated by reference numeral 1 and is especially designed to facilitate transfer of a patient from a bed to a chair (be it a conventional chair, a wheelchair or a shower or toilet chair), and vice versa.

Referring to the embodiment shown in FIGS. 1 to 4, the patient lift apparatus 1 comprises a static support structure 1A, a pivotable transfer structure 1B that is pivotably supported by a bearing portion 10 of the static support structure 1A so as to pivot about a substantially vertical pivot axis PA, and a hoisting device 50 with two lifting straps 50a, 50b configured to selectively lift or lower a patient, as is known for instance from International (PCT) Publication No. WO 2005/074853 A1. The hoisting device 50 is provided at a radial outward end portion 1b of the pivotable transfer structure 1B. Each lifting strap 50a, 50b is provided with a corresponding hook portion 50A, resp. 50B for attachment to a sling or like harness (not shown). For the sake of illustration, the distance separating the two lifting straps 50a, 50b is of approximately 40 cm, which dimension is by no means limiting.

In the illustrated example, the static support structure 1A is a three-leg support structure configured to allow support of the patient lift apparatus 1 onto a floor portion FL. More specifically, the three-leg static support structure 1A comprises a longitudinal leg 11 and two lateral legs 12A, 12B extending transversally with respect to the longitudinal leg 11, the longitudinal leg 11 and the two lateral legs 12A, 12B extending from a base of the bearing portion 10, thereby forming an essentially T-shaped support structure. The legs 11, 12A, 12B are preferably secured to the base of the bearing portion 10 by means of bolts (or any other suitable securing means) to facilitate dismantling thereof from the base. In addition, the leg 11 is preferably designed to be dismantlable in two leg sections 11A, 11B.

In the illustrated example, the pivotable transfer structure is a substantially L-shaped structure comprising a substantially vertical mast section 20 extending from the bearing portion 10 along the pivot axis PA and a substantially horizontal boom section 25 extending perpendicularly to the pivot axis PA. The hoisting device 50 is provided at a radial outward end portion 1b of the boom section 25. The mast section 20 and boom section 25 are likewise preferably dismantlable. In the illustrated example the boom section 25 is connected to the mast section 20 via an intermediate coupling section 22 (here shown as a curved section). Releasable locking of the sections 20, 22, 25 one onto the other is ensured by removable locking pins 25.1 and 20.1. A removable locking pin 20.2 is further provided at a lower end of the mast section 20, next to a base 20A of the mast section 20.

Positioned on an intermediate portion of the mast section 20 is a control unit 40, including e.g. a remote control that can be used to control operation of the hoisting device 50 in a manner known as such in the art.

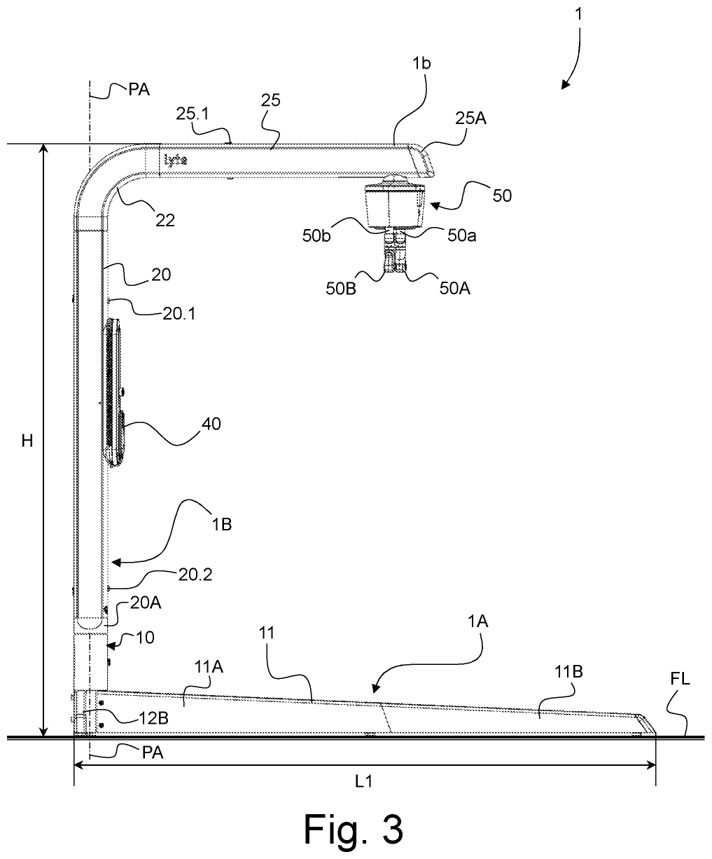

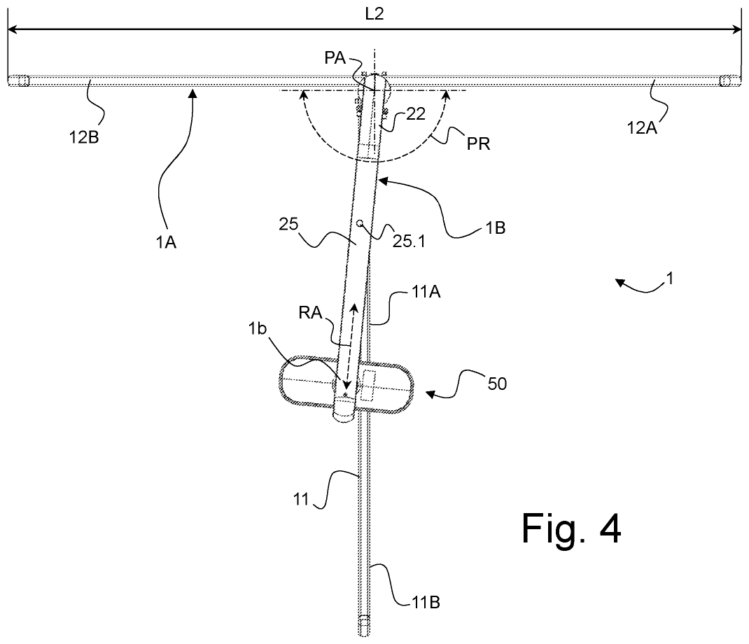

By way of preference, a longitudinal length L1 of the patient lift apparatus 1, as measured parallel to a length of the longitudinal leg 11 (see FIG. 3), is of the order of 2'000 mm or more. A lateral length L2 of the patient lift apparatus 1, as measured parallel to a length of the lateral legs 12A, 12B (see FIG. 4), is of the order 2'600 mm or more (each lateral leg 12A, 12B measuring of the order of 1'300 mm). A height H of the patient lift apparatus 1 (see FIG. 3) preferably exceeds 2'000 mm. In the illustrated example, the height H is of the order of 2'100 mm. A length of the boom section 25, as measured with respect to the pivot axis PA, is preferably of the order of 1'200 mm. Such dimensions have been selected to ensure a stable support of the patient lift apparatus 1 on floor surfaces having an angle of inclination not exceeding 10°. It will be understood however that other dimensions could be contemplated.

In the illustrated example, the pivotable transfer structure 1B is pivotable by hand about the pivot axis PA. In other embodiments, additional means could be provided to automate such pivoting movement if needed or desirable.

In the context of the illustrated embodiment, a pivoting range, designated PR, of the pivotable transfer structure 1B is such that the pivotable transfer structure 1B is not allowed to move outside of an imaginary volume coinciding with a floor area covered by the static support structure 1A, the pivoting range PR of the pivotable transfer structure 1B being less than 180°. In use, the patient lift apparatus 1 is normally positioned against a wall of a room, with the longitudinal leg 11 extending away from the wall and the lateral legs substantially aligned with the wall. One of the lateral legs 12A, 12B can be positioned below the bed, which bed is aligned, longitudinally, with the longitudinal leg 11. The pivoting range PR does not exceed 180° to prevent the pivotable transfer structure 1B (and associated hoisting device 50) from inadvertently hitting the wall. In effect, a range-limiting mechanism is preferably provided to ensure that the pivoting range PR does not exceed a certain range.

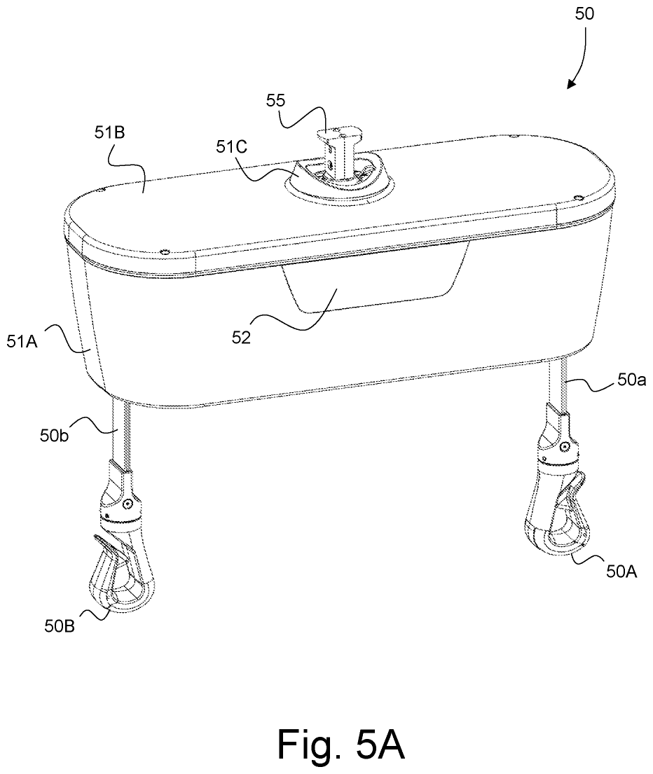

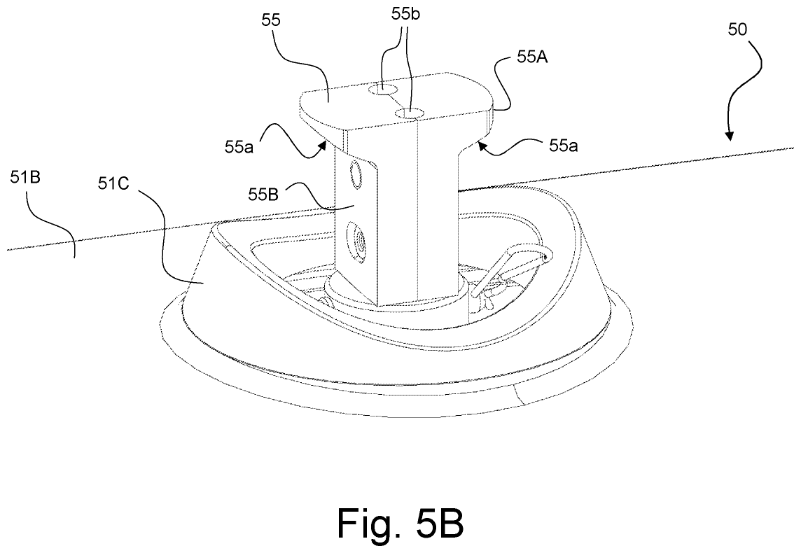

Turning to FIG. 5A-B to 8, one will now describe a further aspect pertaining to the hoisting device 50 and the coupling interface thereof with the boom section 25.

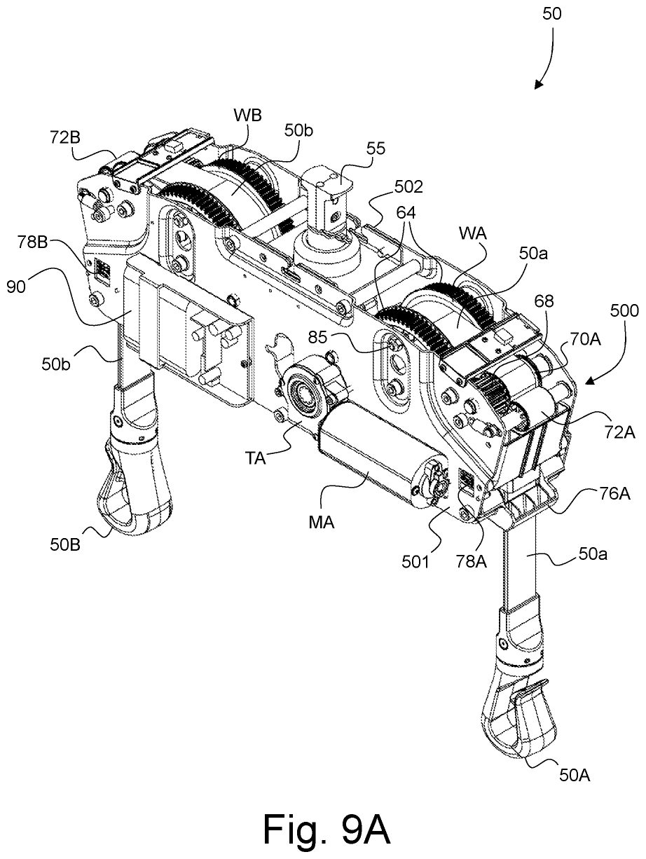

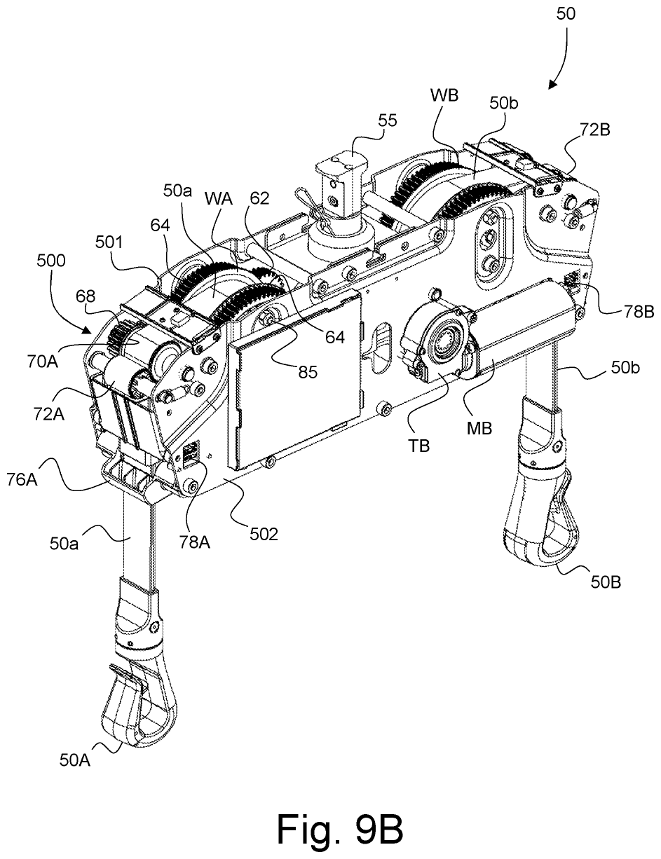

FIG. 5A shows the hoisting device 50 in isolation, the particular structure and configuration of which is discussed in greater detail with reference to FIGS. 9A-B to 12. It suffices to understand, at this stage, that the lifting straps 50a, 50b are wound or unwound onto first and second winding spools located within the hoisting device 50 and that the hoisting device 50 is further provided with a built-in scale to measure load applied on the hoisting device 50, in particular for the purpose of determining the weight of the patient being lifted.

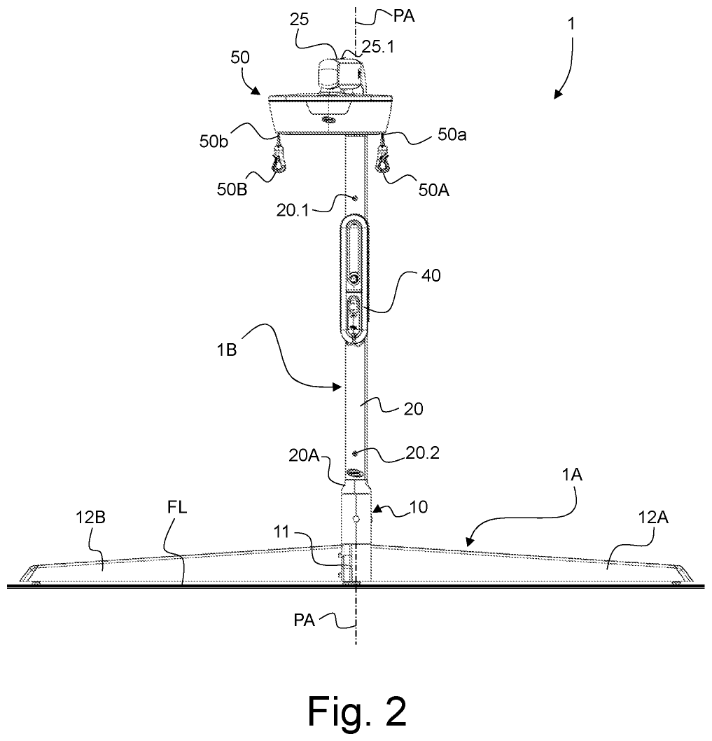

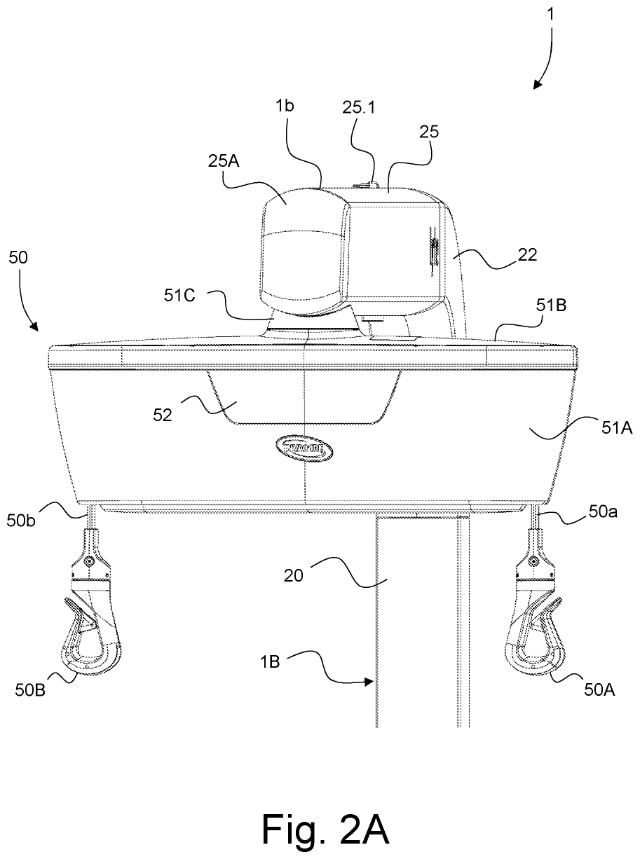

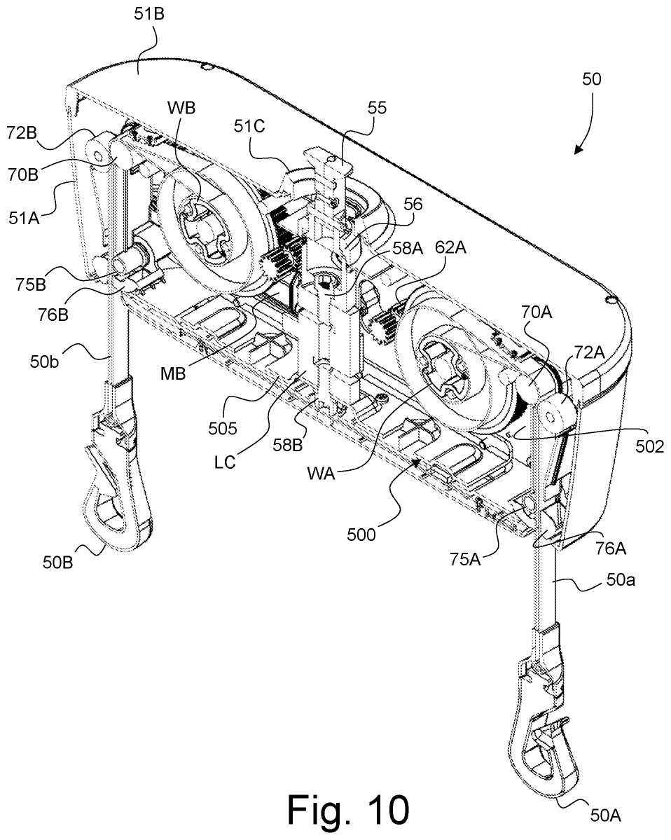

All of the functional components of the hoisting device 50 (including the aforementioned built-in scale) are housed within a housing 51A-C, including a main housing element 51A, an upper housing element 51B, as well as a further housing element 51C surrounding a mounting element, designated by reference numeral 55, that is used to mount the hoisting device 50 under the boom section 25 (see also FIGS. 1A and 2A). The two lifting straps 50a, 50b protrude from the underside of the main housing element 51A through corresponding apertures (as visible in FIG. 10). Reference numeral 52 in FIG. 5A (and FIGS. 1A and 2A) designates a display provided on a front face of the hoisting device 50 that can be used to display information, including e.g. the weight of the patient being lifted as measured by the built-in scale. Further functional elements could be provided, including e.g. an ambient lighting system (e.g. a LED system) located on a bottom section of the hoisting device 50 to illuminate the area below the hoisting device 50.

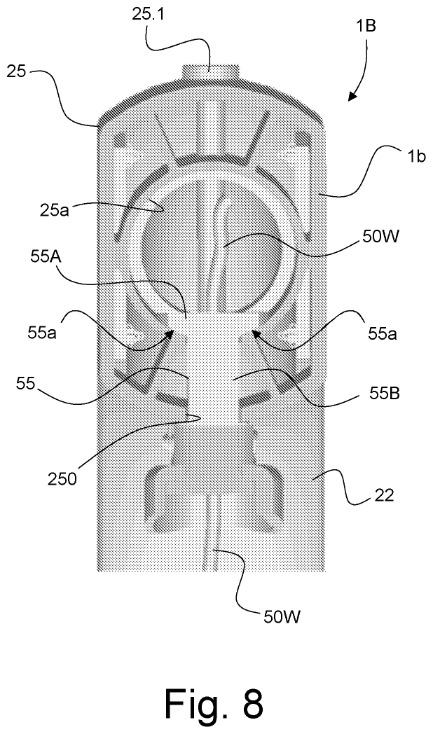

FIG. 5B is an enlarged perspective view showing the mounting element 55 in greater detail. This mounting element 55 and the associated structure on the boom section 25 are configured in such a way as to allow the hoisting device 50 to be selectively released from the boom section 25. To this end, the mounting element exhibits a head section 55A and a neck section 55B. The lower portion of the head section 55A, on either side of the neck section 55B preferably exhibits chamfered surfaces 55a as shown. Furthermore, a pair of through-holes 55b extending all the way vertically through the mounting element 55 are provided. The through-holes 55b allow passage and routing of wiring 50W (see FIG. 8) from the hoisting device 50 inside the boom section 25 for connection e.g. to the aforementioned control unit 40 and associated remote control.

The mounting element 55 is secured mechanically to the hoisting device 50 to ensure adequate support thereof. As this will be described later on, the mounting element 55 is coupled to the built-in scale to measure load applied onto the hoisting device 50, but the mounting element 55 could alternatively be connected directly to a structural frame of the hoisting device 50.

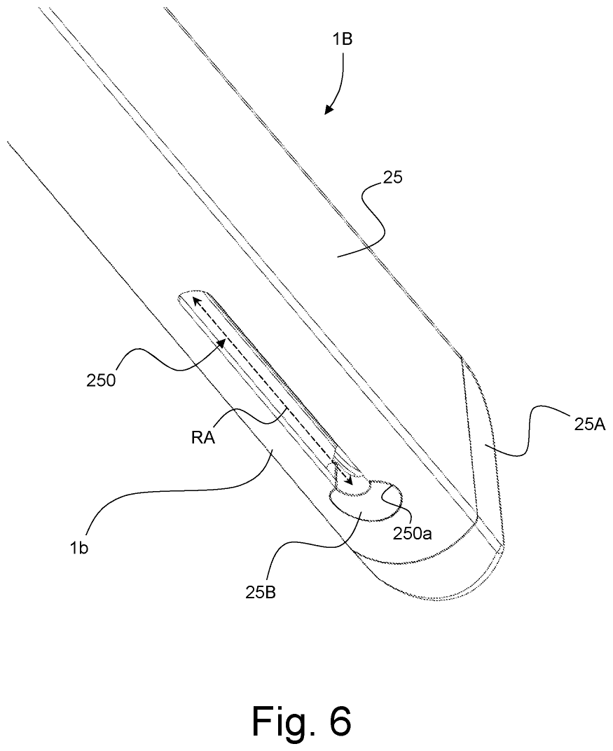

FIG. 6 is a partial perspective view of the underside of the radial outward end portion 1b of the pivotable transfer structure 1B, namely of the boom section 25, without the hoisting device 50. FIG. 6 shows the provision of a longitudinal mounting slot 250 that extends longitudinally along a portion of the radial outward end portion 1b of the boom section 25, namely over a distance designated by reference RA. At the outermost end of the longitudinal mounting slot 250 there is provided a mounting aperture 250a that is large enough to allow the mounting element 55 to be extracted out of or inserted into the boom section 25. FIG. 6 also shows the presence of a removable stop element 25B that is here positioned to close the mounting aperture 250a and thereby prevent inadvertent disengagement of the mounting element 55 and associated hoisting device 50. This removable stop element 25B can be positioned and secured in place via a front end of the boom section 25, namely after removal of a front cap 25A provided at the distal end of the boom section 25.

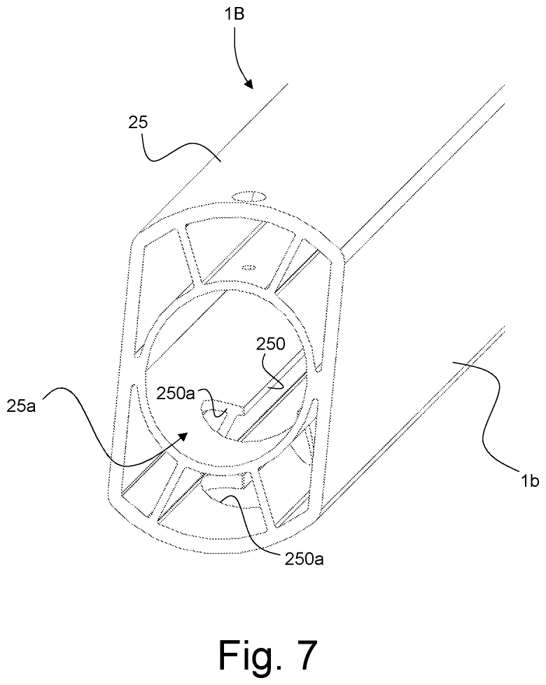

FIG. 7 shows the distal end of the boom section 25 with the front cap 25A removed, as well as the removable stop element 25B. As shown, the boom section 25 here takes the shape of a profiled section (such as e.g. an aluminium profile) that is shaped to exhibit a longitudinal inner channel 25a that is configured and dimensioned to receive the head section 55A of the mounting element 55. Reinforcing ribs are here provided around the longitudinal inner channel 25a to maximize structural strength and robustness of the boom section 25.

Both of the aforementioned longitudinal mounting slot 250 and mounting aperture 250a communicate with the longitudinal inner channel 25a, the longitudinal mounting slot 250 being configured and dimensioned to receive and guide the neck section 55B of the mounting element 55. More specifically, in the illustrated embodiment, the neck section 55B can be slid along the longitudinal mounting slot 250 when no load is applied onto the mounting element 55. Conversely, as shown in FIG. 8, when load is applied on the mounting element 55, the head section 55A of the mounting element 55 comes to rest against a portion of an inner peripheral wall of the longitudinal inner channel 25a, on either side of the longitudinal mounting slot 250. In effect, the configuration is such that the mounting element 55 is prevented from freely moving along the longitudinal mounting slot 250 due to the applied load. The aforementioned chamfered surfaces 55a on the head section 55A of the mounting element 55 favour a more intimate connection between the mounting element 55 and the inner peripheral wall of the inner channel 25a.

The boom section 25 and mounting element 55 may both be made of metal and the inner peripheral wall of the of the longitudinal inner channel 25a may be provided with a friction-enhancing sleeve or liner, which friction-enhancing sleeve or liner is preferably made of rubber.

In the illustrated example, the radial position of the hoisting device 50 is preferably adjustable along the radial outward end portion 1b of the boom section 25 over a range RA of the order of 100 mm or more. In that respect, the radial position of the hoisting device 50, as measured with respect to the pivot axis PA, is in particular adjustable from approximately 900 mm to 1'000 mm or more. One will understand that the effective range of operation of the patient lift apparatus 1 covers an arcuate region defined by variables PR and RA. It will be understood that the radial position of the hoisting device 50 along the boom section 25 is normally set once for good depending on the need, desire and corpulence of the patient and the relevant room configuration, and that this radial position is not normally adjusted during operation of the patient lift apparatus 1, it being however possible to carry out subsequent adjustments in case of need.

FIGS. 9A and 9B are perspective views of the hoisting device 50 of FIG. 5A with the housing 51A-C and display 52 removed for the sake of explanation, revealing the internal structure of the hoisting device 50.

The configuration of the hoisting device 50 takes inspiration from the known hoisting device disclosed in International (PCT) Publication No. WO 2005/074853 A1, however with a number of modifications and improvements. Like the known hoisting device, the hoisting device 50 includes first and second winding spools WA, WB that are configured to allow winding or unwinding of the first and second lifting straps 50a, 50b, respectively, as well as a driving arrangement configured to drive the first and second winding spools WA, WB so as to selectively wind or unwind the first and second lifting straps 50a, 50b.

A fundamental difference, however, resides in that the driving arrangement comprises a first electric motor MA (visible in FIG. 9A) in driving connection with the first winding spool WA and a second electric motor MB (visible in FIG. 9B) in driving connection with the second winding spool WB, and in that the first and second electric motors MA, MB are operable in synchronism to wind or unwind the first and second lifting straps 50a, 50b. While two separate motors MA, MB are used, the size therefore is comparatively smaller than that of the single motor used in connection with the hoisting device of WO 2005/074853 A1 as each motor has to cope with the load demand of one lifting strap only. In effect, the hoisting device 50 of the invention comprises independent drive units configured to operate each winding spool WA, WB and wind or unwind each lifting strap 50a, 50b in a synchronous manner.

The winding spools WA, WB and electric motors MA, MB (and other components of the hoisting device 50) are supported by a structural frame 500 including a pair of spaced-apart side frames 501, 502. Most of the functional components of the hoisting device 50 are mounted between the side frames 501, 502, with a few exceptions. The first motor MA is for instance mounted on the outside of the first side frame 501, as shown in FIG. 9A, along with an associated worm gear TA coupled to the output shaft of the electric motor MA. Likewise, the second motor MB is mounted on the outside of the second side frame 502, as shown in FIG. 9B, along with an associated worm gear TB coupled to the output shaft of the electric motor MB. In the illustrated example, the first side frame 501 also supports a battery 90, such as a rechargeable Li-Ion battery, while the second side frame 502 supports an on-board electronic module.

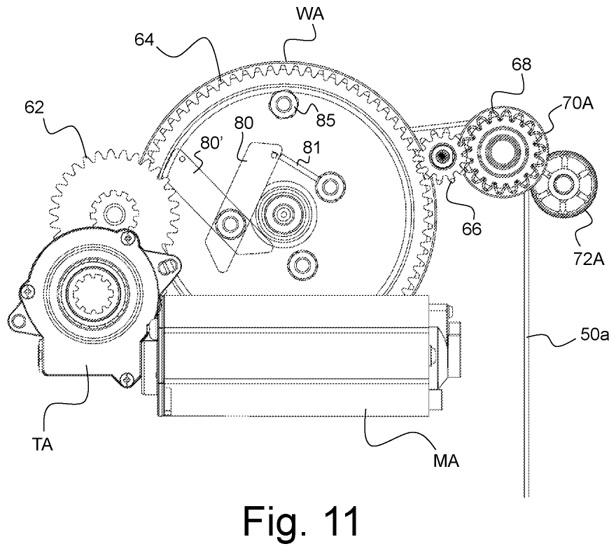

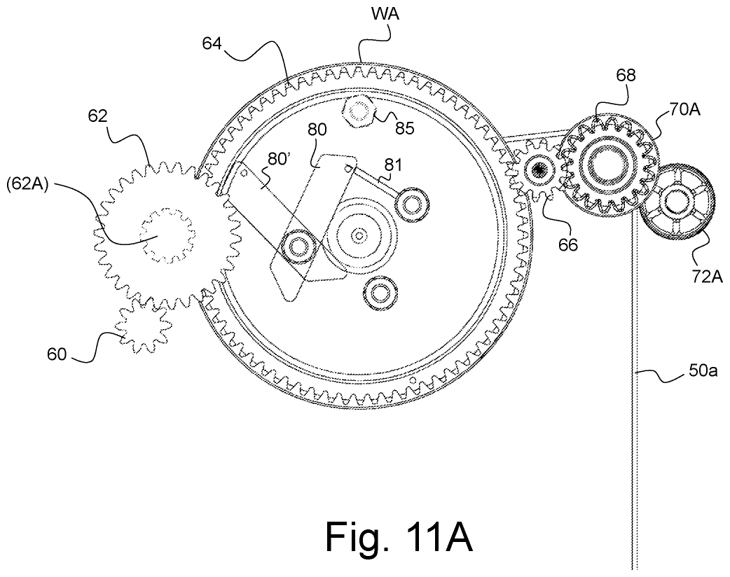

The output of each worm gear TA, TB drives a corresponding pinion located on the other side of the relevant side frame 501, resp. 502, which pinion is not visible in FIGS. 9A-B but shown in FIG. 11A and designated by reference numeral 60. All of the remaining driving components of the hoisting device 50, including the winding spools WA, WB, are interposed between the two side frames 501, 502, as illustrated e.g. in the cross-section of FIG. 10.

The aforementioned drive arrangement is especially an improvement over the known solution disclosed in International (PCT) Publication No. WO 2005/074853 A1 in that space can be freed between the two winding spools WA, WB to include additional components and functionalities, including e.g. a built-in scale. FIG. 10 for instance shows the provision of a strain gauge load cell LC that is coupled between the mounting element 55, on the one hand, and a lower frame element 505 of the structural frame 500, on the other hand (which lower frame element 505 is positioned between the side frames 501, 502 and secured thereto).

A further difference with respect to the known hoisting device of WO 2005/074853 A1 resides in the provision of additional means ensuring adequate tension of the lifting straps 50a, 50b during unwinding operations, as will now be described with reference to FIGS. 9A-B, 10, 11 and 11A. FIGS. 11 and 11A only show part of the driving arrangement that is associated with operation of the first winding spool WA, but it will be appreciated the other part of the driving arrangement that is associated with operation of the second winding spool WB operates along exactly the same principle.

As shown in FIGS. 11 and 11A, a first guide roller 70A is provided, along the path of the first lifting strap 50a so that the circumferential surface thereof contacts a first side of the lifting strap 50a. As shown in FIG. 10, a second guide roller 70B is similarly provided along the path of the second lifting strap 50b. More specifically, in the illustrated example, each lifting strap 50a, 50b is guided along a part of the circumference of the associated guide roller 70A, resp. 70B. Each of the guide rollers 70A, 70B is supported by a one-way bearing configured such that each roller 70A, 70B is forcibly driven into rotation upon unwinding of the associated lifting strap 50a, 50b from the associated winding spool WA, WB, but remains free to rotate in an opposite direction upon winding of the associated lifting strap 50a, 50b onto the associated winding spool WA, WB. More specifically, each of the guide rollers 70A, 70B is forcibly driven into rotation upon unwinding of the associated lifting strap 50a, 50b from the associated winding spool WA, WB such that a tangential speed of the circumferential surface of each of the first and second guide rollers 70A, 70B is greater than an effective tangential speed at which the associated lifting strap 50a, 50b is unwound from the associated winding spool WA, WB.

In one embodiment, each guide rollers 70A, 70B could be forcibly driven into rotation by means of a separate motor. By way of preference, however each guide roller 70A, 70B is forcibly driven into rotation by the associated electric motor MA, resp. MB, via a geartrain as shown in FIGS. 11 and 11A.

More specifically, each geartrain includes a toothed wheel 64 coupled to the associated winding spool WA, WB, a gear wheel 68 coupled to the one-way bearing of the associated guide roller 70A, 70B, and an intermediate pinion wheel 66 meshing with the toothed wheel 64 and with the gear wheel 68.

Even more specifically, each winding spool WA, WB is coupled to a pair of axially spaced-apart toothed wheels 64, as shown in FIGS. 9A-B, one forming part of the aforementioned gearing. Each pair of toothed wheels 64 cooperate with a driving pinion 62A driven by the associated electric motor MA, MB, the winding spool WA, WB being positioned between the pair of axially spaced-apart toothed wheels 64. The driving pinion 62A is journaled between the two side frames 501, 502 to drive each pair of toothed wheels 64. The driving pinion 62A forms an integral part of a pinion-wheel arrangement that further comprises a driving wheel 62 that meshes with the pinion 60 that is coupled to the associated worm gear TA, resp. TB, as shown in FIGS. 11 and 11A.

Thanks to the aforementioned gearing, each guide roller 70A, 70B is forcibly driven into rotation to create tension in the lifting strap 50a, resp. 50b upon unwinding from the associated winding spool WA, WB, thereby preventing jamming or blocking of the lifting straps 50a, 50b during unwinding operations.

Even more preferably, first and second spring-loaded idle rollers 72A, 72B are further provided for cooperation with the guide rollers 70A, 70B. More specifically, each spring-loaded idle roller 72A, 72B is provided such that a circumferential surface thereof contacts a side of the associated lifting strap 50a, resp. 50b, opposite to the side which contacts the circumferential surface of the guide roller 70A, 70B. Each idle roller 72A, 72B is urged under the action of a spring towards the associated guide roller 70A, 70B to press the associated lifting strap 50a, 50b against the associated guide roller 70A, 70B, thereby maintaining adequate friction and engagement to maintain tension in the lifting straps 50a, 50b during unwinding. As a result, a sliding movement is generated between each lifting strap 50a, 50b and the associated guide roller 70A, 70B due to the forced rotation thereof, and the thus generated friction has the effect of creating and maintaining tension in the lifting 50a, 50b as it is being unwound from the associated winding spool WA, WB.

From a general perspective, a ratio of the tangential speed of the circumferential surface of each of the first and second guide rollers 70A, 70B to the effective tangential speed at which the associated lifting strap 50a, 50b is unwound from the associated winding spool WA, WB is advantageously greater than 1 and up to the order of 2 to 2.5. In the illustrated example, the ratio of the relevant tangential speeds is actually determined by the pitch diameter D₆₄ of the toothed wheel 64, the effective diameter of the winding spool WA, resp. WB in a fully wound state (referred to hereafter as D_{Wmax}), and the effective diameter of the winding spool WA, resp. WB in a fully unwound state (referred to hereafter as D_{Wmin}). By way of illustration, assuming a pitch diameter D₆₄ of 108 mm, a maximum effective diameter D_{Wmax} in the fully wound state of 91.3 mm, and a minimum effective diameter D_{Wmin} in the fully unwound state of 53.2 mm, the tangential speed of the circumferential surface of each of the first and second guide rollers 70A, 70B will vary from 1.18 (=D₆₄/D_{Wmax}) to 2.03 (=D₆₄/D_{Wmin}) times the effective tangential speed at which the associated lifting strap 50a, 50b is unwound from the associated winding spool WA, WB. In the illustrated example, it will thus be appreciated that the effective tangential speed at which the lifting strap 50a, resp. 50b is unwound from the winding spool WA, resp. WB, is not constant and depends on how much of the lifting strap is present on the winding spool WA, WB. The pitch diameter D₆₄ of the toothed wheel 64 is thus selected to be greater than the aforementioned maximum effective diameter D_{Wmax} to ensure that the tangential speed of the circumferential surface of each guide roller 70A, 70B is always greater than the tangential speed at which the lifting strap 50a, 50b is unwound from the associated winding spool WA, WB to maintain tension in the lifting strap 50a, 50b.

In other embodiments, a substantially constant ratio could be maintained, if needed, by using separate motors to drive the first and second guide rollers 70A, 70B and by adjusting the speed thereof to compensate for the varying speed at which the lifting straps 50a, 50b are unwound from the associated winding spools WA, WB.

As shown in FIGS. 9A-B to 10, the hoisting device 50 further comprises third and fourth guide rollers 75A, 75B whose circumferential surface likewise contacts the associated lifting strap 50a, 50b, each guide roller 75A, 75B being journaled in an associated bushing 76A, 76B through which the lifting strap 50a, 50b is guided. Each bushing 76A, 76B is designed to allow it to move away from a default position, within a limited range of movement, in case of a slackening of the associated lifting strap 50a, 50b. Such movement is designed to cause activation of an associated microswitch (or more precisely a pair of microswitches on each side) 78A, 78B designed to signal that the associated electric motor MA, MB should be turned off.

Further shown in FIGS. 11 and 11A is the presence of a centrifugal brake element 80 that is configured to stop undesired swift unwinding of each lifting strap 50a, 50b. In a manner known as such in the art (see International (PCT) Publication No. WO 2005/074853 A1), the centrifugal brake element 80 is designed to pivot from a default position and be urged outward during an unwinding operation to take an active position (as designated by reference 80′) if the centrifugal force happens to be too high, such that the brake element 80′ comes in abutment with a dedicated stop element 85, thereby mechanically stopping and preventing any further unwinding of the winding spool WA, WB. Upon being released, the brake element is returned to its default position, designated by reference numeral 80, under the action of a return spring 81.

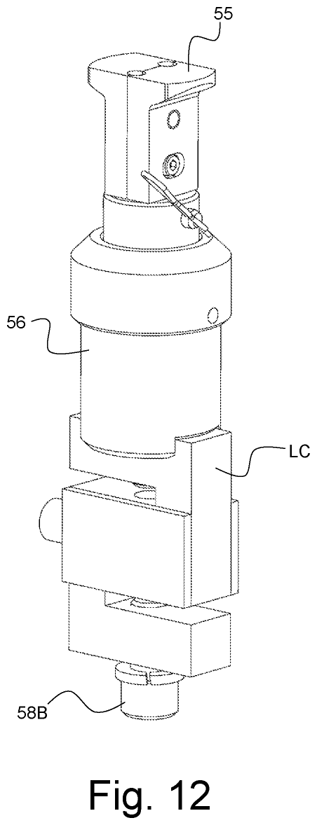

FIG. 12 is a partial perspective view of the strain gauge load cell LC that is coupled to the mounting element 55, which strain gauge load cell LC is configured to measure load applied on the hoisting device 50. This arrangement is in particular used to act as built-in scale to measure e.g. the weight of the patient being lifted. In the illustrated embodiment, the strain gauge load cell LC is an S-type load cell, but other types of load cells could be used.

As already mentioned, the strain gauge load cell LC is positioned in a spacing located between the first and second winding spools WA, WB, which is made possible thanks to the driving arrangement discussed above. In the illustrated example, the strain gauge load cell LC is interposed between the structural frame 500 (namely the lower frame element 505) and the mounting element 55 that is used to hang the hoisting device 50. More specifically, a coupling element 56 is provided, which coupling element 56 is coupled between a first, upper end of the strain gauge load cell LC (by means of a bolt 58A— see FIG. 10) and a lower end of the mounting element 55. The second, lower end of the strain gauge load cell LC is secured to the lower frame element 505 by means of a bolt 58B (as likewise shown in FIG. 10).

Various modifications and/or improvements may be made to the above-described embodiments without departing from the scope of the invention as defined by the annexed claims.

For instance, while the hoisting device has been described in the particular context of a patient lift apparatus as shown e.g. in FIG. 1, the hoisting device of the invention could be supported by wall- or ceiling-mounted overhead tracks or by a gantry structure as known as such in the art.

### LIST OF REFERENCE NUMERALS AND SIGNS USED THEREIN

1 patient lift apparatus
1A static support structure/three-leg support structure
1B pivotable transfer structure
1b radial outward end portion of pivotable transfer structure 1B (radial outward end portion of boon section 25)
10 bearing portion of static support structure 1A pivotably supporting pivotable transfer structure 1B
11 longitudinal leg of static support structure
11A, 11B dismantlable leg sections of longitudinal leg 11
12A, 12B lateral legs
15 lateral leg with angled section
15A angled section of lateral leg 15
20 mast section of pivotable transfer structure 1B
20A base of mast section 20
20.1 removable locking pin
20.2 removable locking pin
22 intermediate coupling section
25 boom section of pivotable transfer structure 1B
25A removable front cap of boom section 25
25B removable stop element
25.1 removable locking pin
25a inner channel of boom section 25
40 control unit
50 hoisting device
50A (first) hook portion for sling (not shown)
50a (first) lifting strap
50B (second) hook portion for sling (not shown)
50b (second) lifting strap
50W wiring for e.g. connection of hoisting device 50 to control unit 40
51A-C housing of hoisting device 50
52 display
55 mounting element of hoisting device 50
55A head section of mounting element 55
55a chambered surfaces on lower portion of head section 55A
55b through-holes allowing passage of wiring 50W
55B neck section of mounting element 55
56 coupling element coupling first end of strain gauge load cell LC to mounting element 55
58A (first) bolt securing first end of strain gauge load cell LC to coupling element 56
58B (second) bolt securing second end of strain gauge load cell LC to lower frame element 505
60 pinion coupled to output of worm gear TA, TB
62 driving wheel meshing with pinion 60
62A driving pinion coupled to driving wheel 62
64 pair of toothed wheels coupled to winding spool WA, resp. WB and meshing with driving pinion 62A
66 intermediate pinion meshing with one of the toothed wheels 64
68 gear wheel coupled to one-way bearing and meshing with intermediate pinion 66
70A (first) guide roller contacting first side of first lifting strap 50a
70B (second) guide roller contacting first side of second lifting strap 50b
72A (first) spring-loaded idle roller contacting opposite side of first lifting strap 50a and cooperating with guide roller 70A
72B (second) spring-loaded idle roller contacting opposite side of second lifting strap 50b and cooperating with guide roller 70B
75A (third) guide roller contacting first side of first lifting strap 50a, journaled in bushing element 76A
75B (fourth) guide roller contacting first side of second lifting strap 50b, journaled in bushing element 76B
76A (first) bushing element
76B (second) bushing element
78A pair of microswitches cooperating with bushing element 76A (detection of slackening of first lifting strap 50a)
78B pair of microswitches cooperating with bushing element 76B (detection of slackening of second lifting strap 50b)
80 centrifugal brake element (default position)
80′ centrifugal brake element (active position)
81 return spring coupled to centrifugal brake element 80
85 stop element secured to side frame 501, resp. 502
90 battery
250 longitudinal mounting slot communicating with longitudinal inner channel 25a of boom section 25
250a mounting aperture communicating with longitudinal inner channel 25a of boom section 25
500 inner structural frame of hoisting device 50
501 (first) side frame
502 (second) side frame
505 lower frame element
MA (first) electric motor driving winding spool WA
MB (second) electric motor driving winding spool WB
TA worm gear coupled to output shaft of electric motor MA
TB worm gear coupled to output shaft of electric motor MB
LC strain gauge load cell
FL floor portion
PA pivot axis of pivotable transfer structure 1B
PR pivoting range of pivotable transfer structure 1B
RA range of adjustment of radial position of hoisting device 50 along radial outward end portion 1b of boom section 25
L1 longitudinal length of patient lift apparatus 1 as measured parallel to a length of longitudinal leg 11
L2 lateral length of patient lift apparatus 1 as measured parallel to a length of lateral legs 12A, 12B
H height of patient lift apparatus 1

1-18. (canceled)

19. A hoisting device for a patient lift apparatus, comprising:
first and second lifting straps configured to selectively lift or lower a patient;
first and second winding spools configured to allow winding or unwinding of the first and second lifting straps, respectively; and
a driving arrangement configured to drive the first and second winding spools so as to selectively wind or unwind the first and second lifting straps,
wherein the driving arrangement comprises a first electric motor in driving connection with the first winding spool and a second electric motor in driving connection with the second winding spool, the first and second electric motors being operable in synchronism to wind or unwind the first and second lifting straps,
wherein the hoisting device further comprises a first guide roller whose circumferential surface contacts a first side of the first lifting strap and a second guide roller whose circumferential surface contacts a first side of the second lifting strap,
wherein each of the first and second guide rollers is supported by a one-way bearing configured such that each of the first and second guide rollers is forcibly driven into rotation upon unwinding of the associated lifting strap from the associated winding spool and is free to rotate in an opposite direction upon winding of the associated lifting strap onto the associated winding spool,
and wherein each of the first and second guide rollers is forcibly driven into rotation upon unwinding of the associated lifting strap from the associated winding spool such that a tangential speed of the circumferential surface of each of the first and second guide rollers is greater than an effective tangential speed at which the associated lifting strap is unwound from the associated winding spool.

20. The hoisting device according to claim 19, wherein each of the first and second guide rollers is forcibly driven into rotation by the associated electric motor via a geartrain.

21. The hoisting device according to claim 20, wherein each geartrain includes a toothed wheel coupled to the associated winding spool, a gear wheel coupled to the one-way bearing of the associated guide roller, and an intermediate pinion wheel meshing with the toothed wheel and with the gear wheel.

22. The hoisting device according to claim 19, wherein a ratio of the tangential speed of the circumferential surface of each of the first and second guide rollers to the effective tangential speed at which the associated lifting strap is unwound from the associated winding spool is greater than 1 and up to the order of 2 to 2.5.

23. The hoisting device according to claim 19, further comprising a first spring-loaded idle roller whose circumferential surface contacts a side of the first lifting strap, opposite to the first side, and a second spring-loaded idle roller whose circumferential surface contacts a side of the second lifting strap opposite to the first side,
wherein each of the first and second spring-loaded idle rollers is urged towards the associated guide roller to press the associated lifting strap against the associated guide roller.

24. The hoisting device according to claim 19, further comprising a third guide roller whose circumferential surface contacts the first lifting strap and a fourth guide roller whose circumferential surface contacts the second lifting strap,
wherein each of the third and fourth guide rollers is journaled in an associated bushing through which the associated lifting strap is guided, the bushing being allowed to move away from a default position, within a limited range of movement, in case of a slackening of the associated lifting strap to cause activation of an associated microswitch designed to signal that the associated electric motor should be turned off.

25. The hoisting device according to claim 19, wherein each of the first and second electric motors drives the associated winding spool through a worm gear.

26. The hoisting device according to claim 19, wherein each of the first and second winding spools is coupled to a pair of axially spaced-apart toothed wheels cooperating with a driving pinion driven by the associated electric motor, each winding spool being positioned between the pair of axially spaced-apart toothed wheels.

27. The hoisting device according to claim 19, wherein each of the first and second winding spools further comprises a centrifugal brake element configured to stop undesired swift unwinding of each lifting strap.

28. The hoisting device according to claim 19, further comprising a strain gauge load cell configured to measure load applied on the hoisting device, which strain gauge load cell is positioned in a spacing located between the first and second winding spools.

29. The hoisting device according to claim 28, wherein the strain gauge load cell is designed to provide a measurement of the weight of the patient being lifted by the hoisting device.

30. The hoisting device according to claim 28, further comprising a display to provide an indication of the load measured by the strain gauge load cell.

31. The hoisting device according to claim 28, wherein the strain gauge load cell is interposed between a structural frame of the hoisting device and a mounting element used to hang the hoisting device on a corresponding support of the patient lift apparatus.

32. The hoisting device according to claim 19, further comprising a battery supplying power to the hoisting device.

33. The hoisting device according to claim 32, wherein the battery is a rechargeable battery.

34. A patient lift apparatus comprising a hoisting device according to claim 19.

35. The patient lift apparatus according to claim 34, wherein the patient lift apparatus further comprises a static support structure and a pivotable transfer structure that is pivotably supported by a bearing portion of the static support structure so as to pivot about a substantially vertical pivot axis, the hoisting device being provided at a radial outward end portion of the pivotable transfer structure.

36. A hoisting device for a patient lift apparatus, comprising:
first and second lifting straps configured to selectively lift or lower a patient;
first and second winding spools configured to allow winding or unwinding of the first and second lifting straps, respectively; and
a driving arrangement configured to drive the first and second winding spools so as to selectively wind or unwind the first and second lifting straps,
wherein the driving arrangement comprises a first electric motor in driving connection with the first winding spool and a second electric motor in driving connection with the second winding spool, the first and second electric motors being operable in synchronism to wind or unwind the first and second lifting straps,
and wherein the hoisting device further comprises a strain gauge load cell configured to measure load applied on the hoisting device, which strain gauge load cell is positioned in a spacing located between the first and second winding spools.

37. The hoisting device according to claim 36, wherein the strain gauge load cell is designed to provide a measurement of the weight of the patient being lifted by the hoisting device.

38. The hoisting device according to claim 36, further comprising a display to provide an indication of the load measured by the strain gauge load cell.

39. The hoisting device according to claim 36, wherein the strain gauge load cell is interposed between a structural frame of the hoisting device and a mounting element used to hang the hoisting device on a corresponding support of the patient lift apparatus.

40. The hoisting device according to claim 36, further comprising a battery supplying power to the hoisting device.

41. The hoisting device according to claim 40, wherein the battery is a rechargeable battery.

42. A patient lift apparatus comprising a hoisting device according to claim 36.

43. The patient lift apparatus according to claim 42, wherein the patient lift apparatus further comprises a static support structure and a pivotable transfer structure that is pivotably supported by a bearing portion of the static support structure so as to pivot about a substantially vertical pivot axis, the hoisting device being provided at a radial outward end portion of the pivotable transfer structure.
